(19) United States
(12) Patent Application Publication
(10) Pub. No.: US 2026/0348523 A1
(43) Pub. Date: Nov. 5, 2026

(54) PRESSURIZED GAS TANK FOR A VEHICULE

(71) Applicant: PLASTIC OMNIUM NEW ENERGIES FRANCE, Lyon (FR)

(72) Inventors: Clément NONY-DAVADIE, Bruxelles (BE); Christopher MICHEL, Bruxelles (BE); David RUGGI, Bruxelles (BE); Dominique SUHR, Bruxelles (BE)

(73) Assignee: PLASTIC OMNIUM NEW ENERGIES FRANCE, Lyon (FR)

(21) Appl. No.: 19/484,597

(22) PCT Filed: May 17, 2024
(86) PCT No.: PCT/EP2024/063662

§ 371 Date: Nov. 14, 2025

(30) Foreign Application Priority Data
May 19, 2023 (FR) FR2304976

(51) Int. Cl. F17C 1/06; F17C 13/00

(52) U.S. Cl. CPC F17C 1/06; F17C 13/002; F17C 2201/0109; F17C 2203/0604; F17C 2203/0607; F17C 2203/0621; F17C 2209/2163; F17C 2270/0168

(57) ABSTRACT

A pressurized tank includes a composite reinforcing structure, at least partially coated with a protective coating. The protective coating includes at least two polyurea-based protective layers, at least one of the protective layers based on one or more polyureas further includes at least one fire retardant agent that is an intumescent agent, the one or more polyureas being one or more products of the reaction between at least one hardener and at least one resin, at least one resin of a first polyurea-based protective layer being different from at least one resin of a second polyurea-based protective layer, the protective layer containing the intumescent agent being the outermost layer of the coating. The application also relates to a method for preparing such a tank and to a vehicle including such a tank.

The invention relates to the field of pressurized tanks for vehicles, such as motor vehicles, trucks, buses, trains, and even boats. The invention relates more particularly to a pressurized gas tank for a vehicle, as well as to a vehicle comprising such a pressurized gas tank, and to a method for preparing such a pressurized gas tank.

Pressurized gas tanks are used to store and transport all types of pressurized gas. Pressurized gas tanks are generally classified into one of five types: a type I pressurized gas tank having an all-metal construction; a type II pressurized gas tank having a metal construction including a fiber winding for reinforcing the cylindrical part thereof; a type III pressurized gas tank having a metal liner with a composite reinforcing structure; a type IV pressurized gas tank comprising a plastic liner with a composite reinforcing structure; and a type V pressurized gas tank having a composite reinforcing structure and no liner.

A pressurized gas tank is already known from the prior art which is, for example, configured to store gas at a pressure of at least 350 bar or at least 700 bar, the gas being hydrogen, for example. Thus, this pressurized gas tank is configured to be used by a vehicle equipped with the pressurized gas tank for various functions, as an energy source. This tank is usually made of composite material for weight and safety reasons.

Such a pressurized gas tank conventionally consists of an inner envelope referred to as a liner, which has a function of sealing against the gas contained in the tank. The liner is, for example, made of a plastic material, in the case of a type IV tank, chosen for its lightness and low manufacturing cost, or of a metal such as aluminum, or of another material such as a metal alloy, in the case of a type III tank. Thus, the “plastic” liner comprises at least one opening for filling and emptying the tank. It is manufactured by injection or by rotational molding or by extrusion blow molding of a thermoplastic or thermosetting polymer such as polyethylene, polyamide, polyphthalamide, polyurethane, silicone, or polyoxymethylene, for example. Advantageously, in the case of a type IV tank, the plastic selected for the liner can be loaded with fibers, nanometric or micrometric particles, or even be composed of several layers. The reinforcing fibers are, for example, glass fibers, carbon fibers, basalt fibers, aramid fibers, polymer fibers, silica fibers, polyethylene fibers, natural fibers, metal fibers, metal alloy fibers, or ceramic fibers. The particles can be selected from different types of materials, such as ceramics, glass, metals, organic materials, or a combination thereof, for example. These fillers increase the deformation resistance of the resulting material. In a polymer material filled with reinforcing fibers, the reinforcing fibers and the polymer material are entangled to form a single-piece material. In the case of multi-layer stacking, these can be obtained from different materials, such as metals or organic materials, for example. This multi-layer approach reduces the gas permeability of the liner. The two approaches mentioned above can be combined.

The liner is generally cylindrical in shape, with two dome-shaped ends. The liner includes an opening, which is generally topped by a gas filling/distribution nozzle. The pressurized fluid exerts high stresses on the inner surface of the liner, which can damage the integrity of the liner and cause dangerous leaks, especially with combustible gases such as hydrogen.

To improve the mechanical properties of the pressurized gas tank, the liner is surrounded by a composite reinforcing structure, generally made by winding resin-impregnated fiber strips around the liner at different angles. The fibers used can be selected from ceramics, glass, and organic materials. For example, carbon fibers, glass fibers, and aramid fibers are commonly used. The resins in question can be thermosetting or thermoplastic resins. For example, epoxy or vinyl ester resins are used for thermosetting resins, and polyamide or polyetheretherketone (PEEK) resins are used for thermoplastic resins. The winding process can be carried out wet, with the fibers immersed in a resin bath before being wound, or dry, with the fibers in the form of a resin-impregnated strip of parallel fibers, more commonly known as a “Towpreg.” The resins used can be loaded with nanometric and/or micrometric particles to improve the properties of the composite reinforcing structure. These particles can be based on a material selected from ceramic materials, glasses, metals, organic materials, or any combination thereof. For example, hollow glass beads can be used to lighten and reduce the risk of delamination of the composite reinforcing structure; graphene or carbon nanotubes can be used to improve the electrical or thermal properties of the composite reinforcing structure, and reduce the risk of delamination of the composite reinforcing structure; rubber beads can be used to increase ductility, reduce the risk of delamination, and reduce residual stresses within the composite reinforcing structure.

However, these pressurized tanks must withstand chemical and/or mechanical stresses to meet safety standards for use in motor vehicles. In particular, they must meet the requirements set out in Regulation No. 134 of the Economic Commission for Europe of the United Nations (UN/ECE)—Uniform provisions concerning the approval of motor vehicles and their components with regard to the safety-related performance of hydrogen-fuelled vehicles [2019/795].

In their normal conditions of use, as defined by certification standards, high-pressure tanks for transport applications must be able to withstand various types of external stresses. These include chemical stresses linked to exposure to high concentrations of strong acids and bases, or to organic or inorganic solvents, mechanical stresses linked to impacts such as gravel chips when driving, or environmental stresses such as salt spray, ozone exposure, and/or UV exposure. The temperature range over which the tank must retain its properties is from −40 °C to +85 °C at 95% relative humidity in accordance with Regulation No. 134 of the Economic Commission for Europe of the United Nations (UN/ECE)—Uniform provisions concerning the approval of motor vehicles and their components with regard to the safety-related performance of hydrogen-fuelled vehicles [2019/795].

Typically, this resistance to chemical, mechanical, and/or thermal stresses is provided by an additional layer of protection on the outside of the tank. This usually consists of either a layer of fiberglass impregnated with intumescent resin (applied by dry or wet filament winding), or an intumescent coating, usually based on a two-component (2K) epoxy applied by spraying, direct dosage, or injection, or a combination thereof. The epoxy-based protective layer contains intumescent agents which, after exposure to fire, expand to create an insulating barrier. The expansion and calcination of the resin by the intumescent reaction reduces and slows the heat transfer from flames to the composite reinforcing structure, also known as the “laminate,” delaying the decomposition of the laminate resin. This phenomenon enables the quick-drain equipment installed on gas filling/distribution nozzles, also known as “bases,” to purge the tank and prevent failure thereof.

However, such protective layers cannot guarantee a satisfactory level of protection for the composite reinforcing structure at minimum thicknesses due to their intrinsic fragility. For example, the formation of post-impact cracks creates a path allowing, among other things, chemicals to come into contact with the composite reinforcing structure and thus to corrode it. This corrosion increases the risk of tank failure. This phenomenon of post-impact cracking is exacerbated at sub-zero temperatures.

Furthermore, the epoxy-based system has no impact-absorbing properties at low temperatures. Further, the epoxy-based system requires long curing times at room temperature, necessitating the use of furnaces to accelerate curing and thus increased costs. This delay in curing, linked to the duration of cross-linking, may also lead to sagging of the composite reinforcing structure and the formation of air pockets, resulting in points of weakness within it.

US 2011/313084 A1 discloses coating compositions, including a composition comprising a protective layer containing a flame-retardant agent in the form of an intumescent agent, and a composition comprising polyurea-based or polyurea and polyurethane-based protective layers.

It is therefore desirable to have a protective layer capable of withstanding the chemical, mechanical, and thermal stresses imposed on the tank, over wide temperature ranges, and without these disadvantages. It is also desirable for the protective layer to have these properties while being relatively light.

Unexpectedly, it has been found by the inventors that these and other aims can be achieved with a polyurea-based protective coating, preferably applied in specified ways.

Consequently, the object of the present invention is a pressurized tank comprising at least one composite reinforcing structure, at least partially coated with a protective coating, wherein the protective coating comprises at least two polyurea-based protective layers, at least one of the protective layers based on polyurea further comprising at least one fire retardant agent that is an intumescent agent, the one or more polyureas being products of the reaction between at least one hardener and at least one resin, for which: (i) the resin is an aromatic or aliphatic polyamine compound, optionally substituted with at least one alcohol function; (ii) the hardener is an aromatic, cycloaliphatic, heterocyclic, alicyclic, or aliphatic polyisocyanate compound, and reaction products thereof in the form of aliphatic or aromatic oligomers; at least one resin of a first polyurea-based protective layer being different from at least one resin of a second polyurea-based protective layer, the protective layer containing an intumescent agent being the outermost layer of the protective coating. Advantageously, the pressurized tank according to the invention comprises a liner and a composite reinforcing structure, and is at least partially coated with a protective coating, which coating comprises at least two polyurea-based protective layers as defined throughout the present text. The liner is especially a plastic material-based liner.

The object of the invention is also a method for preparing such a tank, comprising the following steps:
a) obtaining a mandrel,
b) winding a composite reinforcing structure around at least part of the mandrel to obtain a hollow body,
c) forming a protective coating on at least part of the surface of the composite reinforcing structure, said step of forming the protective coating comprising the steps of:
c1) depositing a mixture (D) of at least one resin and at least one hardener on at least part of the surface of the composite reinforcing structure, the stoichiometric ratio of resin to hardener being between 2:1 and 1:2, preferably between 1.3:1 and 1:1.3, especially substantially equal to 1:1, and polymerizing the mixture (D) to obtain a first polyurea-based protective layer,
c2) depositing a mixture (I) of at least one resin, at least one hardener, and at least one fire retardant agent on at least part of the surface of the hollow body coated with a protective layer obtained in step c1), the stoichiometric ratio of resin to hardener being between 2:1 and 1:2, preferably between 1.3:1 and 1:1.3, especially substantially equal to 1:1, and polymerizing a mixture (I) to obtain a second polyurea-based protective layer, at least one resin in the mixture (D) being different from at least one resin in the mixture (I).

In one embodiment of the invention, the mandrel is a fusible body. It will melt and disappear during subsequent steps of the method.

According to another embodiment of the invention, the mandrel is a liner, especially a plastic liner.

The object of the invention is thus a method for preparing such a tank, comprising the following steps:
a) obtaining a liner, preferably a plastic material-based liner,
b) winding a composite reinforcing structure around at least part of the liner to obtain a hollow body,
c) forming a protective coating on at least part of the surface of the composite reinforcing structure, said step of forming the protective coating comprising the steps of:
c1) depositing a mixture (D) of at least one resin and at least one hardener on at least part of the surface of the composite reinforcing structure, the stoichiometric ratio of resin to hardener being between 2:1 and 1:2, preferably between 1.3:1 and 1:1.3, especially substantially equal to 1:1, and polymerizing the mixture (D) to obtain a first polyurea-based protective layer,
c2) depositing a mixture (I) of at least one resin, at least one hardener, and at least one fire retardant agent on at least part of the surface of the hollow body coated with a protective layer obtained in step c1), the stoichiometric ratio of resin to hardener being between 2:1 and 1:2, preferably between 1.3:1 and 1:1.3, especially substantially equal to 1:1, and polymerizing a mixture (I) to obtain a second polyurea-based protective layer, at least one resin in the mixture (D) being different from at least one resin in the mixture (I).

A further object of the invention is a motor vehicle comprising such a tank, at least part of which is covered by a protective coating.

As is known, a polyurea is a polymer with a plurality of urea bonds (—NH—CO—NH—) resulting from the reaction of a polyamine having at least two primary amine functions with a polyisocyanate, that is, a compound having at least two isocyanate functions.

Other components, especially catalysts and additives, can also be used in polyurea production.

US-A1-2013/0153458 discloses a system for coating a substrate, especially a tank, comprising an inner layer and an outer layer made of polyurethane or polyurea, between which there is an intermediate layer of viscous gel comprising surfactants and polybutadiene, which gel ensures their adhesion.

CN-A-114636095 discloses a hydrogen storage container comprising a liner surrounded by several layers of fibers wound along different axes; a layer of polyurea is spread on the outer surface of the fiber layers.

These documents do not solve the problems underlying the present invention.

In the context of the present invention, resin means an aromatic or aliphatic polyamine compound, optionally substituted with at least one alcohol function. The amine functions can be primary, secondary, or tertiary; preferably, the compound has primary amine functions.

The resin can especially be selected from the group consisting of the following compounds: polyoxypropylenediamine, diethylmethylbenzenediamine, glyceryl poly(oxypropylene)triamine, polyalkyl- or polyaryl-amines and polyetheramines, in particular from ethylene diamine; 1,2-diaminopropane; 1,3-diaminopropane; 2,5-diamino-2,5-dimethylhexane; 1,11-diaminoundecane; 1,12-diaminododecane; 2,4-hexahydrotoluylene diamine; 2,6-hexahydrotoluylene diamine; 2,4′-diamino-dicyclohexyl methane isophoronediamine; N-methyl-propylene-1,3-diamine; 1,6-hexamethylenediamine; 1,4-diaminocyclohexane; 1,3-diaminocyclohexane; N,N′-dimethylethylenediamine; 4,4′-dicyclohexyl-methanediamine; 2,4-diaminotoluene; 2,6-diaminotoluene; 3,5-diethyl-2,4-diaminotoluene; 3,5-diethyl-2,6-diaminotoluene; mono-, di-, tri-or tetra-alkyl-substituted 4,4′-diamino-diphenylmethanes, and amino alcohols such as ethanolamine, 1-aminopropanol, and 2-aminopropanol. Other examples include prepolymers of the Jeffamine® family marketed, for example, by Huntsman, or Hycar® marketed by Goodrich. A prepolymer is an oligomer or polymer with reactive groups that enable it to be involved in subsequent polymerization. An oligomer is a molecule made up of a number of, generally less than ten, identical or very similar elements.

In the context of the invention, a hardener means an aromatic, cycloaliphatic, heterocyclic, alicyclic, or aliphatic polyisocyanate compound, and reaction products thereof; it may be a monomer, polymer, or prepolymer. The polyisocyanate compound comprises at least two isocyanate functions and especially includes di-isocyanates, triisocyanates, tetraisocyanates, and mixtures thereof.

The polyisocyanate compound may, in particular, be selected from the group comprising toluene diisocyanate (TDI), methylene diphenyl diisocyanate (MDI), isophorone diisocyanate (IPDI), hexamethylene diisocyanate (HDI), pentamethylene diisocyanate (PDI), and prepolymers thereof. Preferably, the prepolymers are reacted with each other before being incorporated into the composition.

It is used, in particular, a polyisocyanate compound selected from the polymers of alpha-hydro-omegahydroxypoly[oxy(methyl-1,2-ethanediyl)] with 1,1′-methylenebis[isocyanatobenzene], the reaction mass of 4,4′-methylene diphenyl diisocyanate (MDI) and o-(pisocyanatobenzyl) phenyl isocyanate, 4,4′-methylene diphenyl diisocyanate (MDI), oligomers of 4,4′-methylene diphenyl diisocyanate (MDI), and mixtures thereof.

Aliphatic polyisocyanates are preferred when a non-yellowing product is required.

The stoichiometric ratio of resin component(s) to polyisocyanate compound(s) is generally between 2:1 and 1:2, in particular between 1.8:1 and 1:1.8, preferably between 1.5:1 and 1:1.5, even more preferably between 1.3:1 and 1:1.3. Good results are obtained for protective coatings in which the one or more polyureas are a reaction product of at least one resin and at least one polyisocyanate compound in ratios of 1:1.2 to 1.2:1, in particular, for ratios of around 1:1 plus or minus 5% (1:1.05 to 0.95) or 1:1 plus or minus 3% (1:1.03 to 0.97).

A polyurea-based layer means a layer comprising one or more polyureas, especially a mixture of two, three, or more polyureas; preferably, at least 80% of the layer is composed of polyurea, in particular, the polyurea or polyurea mixture constitutes at least 90%, in particular at least 95% of the polyurea-based layer. These percentages are expressed by weight relative to the total weight of polymers present in the polyurea layer. Fillers, additives, and/or intumescents are not included in this definition of the polyurea-based layer. The polymers in the polyurea-based layer can therefore be 100% polyureas.

According to the invention, at least one resin of a first polyurea-based protective layer is different from at least one resin of a second polyurea-based protective layer.

According to one embodiment, at least one polyisocyanate compound (or hardener) of a first polyurea-based protective layer is different from at least one polyisocyanate compound (or hardener) of a second polyurea-based protective layer.

These two embodiments can be combined, at least one resin and at least one polyisocyanate compound of a first polyurea-based protective layer are different from at least one resin and at least one polyisocyanate compound of a second polyurea-based protective layer.

It is understood that all or part of the polyurea(s) of said first polyurea-based layer is different from the polyurea(s) of said second polyurea-based layer of the protective coating.

The protective coating includes at least two polyurea-based layers, so it can include, in particular, two polyurea-based layers, especially three polyurea-based layers, or even four or more polyurea-based layers.

Additives such as UV absorbers, hindered amine light stabilizers, antioxidants, dispersing and grinding aids, wetting agents, impact modifiers, defoamers, suspension stabilizers, biocides, etc., can be added to the binder to improve the manufacturability and overall durability of the coatings of the present invention.

Advantageously, at least one of the protective coating layers contains at least one additive selected from UV absorbers, light stabilizers, antioxidants, dispersing agents, wetting agents such as surfactants, plasticizing agents, anti-foaming agents, and impact attenuators, also known as impact modifiers. Advantageously, it comprises an additive selected from surfactants that can act as wetting agents and suspension stabilizers.

The number and thickness of the polyurea-based layers in the coating according to the invention will be adapted by the person skilled in the art, depending on the intended properties. In all cases, the overall thickness of the protective coating is less than or equal to 12 mm, especially less than or equal to 8 mm, in particular less than or equal to 4 mm. It is understood that the overall thickness of the protective coating is generally greater than or equal to about 1 mm, in particular greater than or equal to 2 mm. In particular, protective coatings according to the invention have an overall thickness of 2 mm to 4 mm, in particular 2.5 mm to 4 mm.

Advantageously, the one or more polyureas are selected such that the elastic deformation of each polyurea-based protective layer is greater than the maximum elastic deformation of the last layer of the laminate covering the liner, over the entire range of temperature and relative humidity at which the tank is used. Normal operating conditions are defined in UN/ECE Regulation No. 134 (Uniform provisions concerning the approval of motor vehicles and their components with regard to the safety-related performance of hydrogen-fuelled vehicles [2019/795]) published in the Official Journal on May 17, 2019.

Elastic deformation is measured by tensile tests in accordance with ISO 527-1:2019, at temperatures from −45 °C to 85 °C at 95% humidity.

Indeed, it has now been shown that a protective coating according to the present invention meets the safety requirements of the above-mentioned Regulation No. 134.

In particular, it protects the tank at temperatures from −40 °C to +85 °C, can withstand impacts of 30 Joules at −40 °C, and provides resistance to chemical and environmental agents (UV, corrosion); it provides fire resistance by retarding fire through its intumescent properties.

Advantageously, at least one polyurea-based protective layer contains an intumescent agent selected from the group of halogen compounds, phosphorus compounds, boron compounds, metal hydroxides, and metal oxides, and mixtures of at least two of these. The concentration of intumescent agent in the polyurea-based layer can range from 0.1% to 50% by weight, based on the total weight of the polyurea-based layer, and especially from 10 to 24% by weight.

Halogen intumescents are, in particular, selected from chlorine and/or bromine compounds such as polybrominated diphenyl ethers (PBDEs), tetrabromobisphenol A, hexabromocyclododecanes, decabromodiphenyl ethane, Dechlorane plus (a polychlorinated flame retardant produced by OXYCHEM) and short-chain chlorinated kerosenes (SCCPs).

Boron compounds are, in particular, polyborates.

Phosphorus compounds are, in particular, polyphosphates.

In particular, metal hydroxides are selected from aluminum hydroxide and magnesium hydroxide.

Metal oxides are, in particular, selected from the group comprising titanium dioxide, silica, aluminum oxide, and antimony oxide.

The one or more protective layers may especially further include fillers. In particular, at least one of the protective polyurea-based layers contains at least one filler in particle or fiber form, said filler being selected from ceramics, metals, metal oxides, plastics, and mixtures thereof.

Preferably, at least one of the polyurea-based protective layers does not contain an intumescent agent. These one or more protective layers are located inside the protective layer containing at least one intumescent agent.

A protective layer containing no intumescent agent in the coating according to the invention preferably has a glass transition temperature Tg, measured by DMA (dynamic mechanical analysis), which is less than or equal to −40 °C, especially less than or equal to −43 °C, advantageously less than or equal to −45 °C.

Advantageously, a polyurea-based protective layer containing an intumescent agent in the coating according to the invention preferably has a glass transition temperature Tg, measured by DMA (dynamic mechanical analysis) below −20 °C.

Said protective layer containing an intumescent agent advantageously has a degree of expansion at 180 °C of less than twenty times its thickness, preferably less than fifteen times its thickness.

Preferably, in the protective layer containing no intumescent agent, the one or more polyureas are substantially aliphatic: they are prepared, preferably, from amines with long and branched polymeric chains with few aromatic amines.

Preferably, in the protective layer containing an intumescent agent, the one or more polyureas are substantially aromatic: they are preferably prepared from amines with short aliphatic or aromatic chains.

According to one advantageous embodiment, the hardeners used to prepare the polyureas of each of said first and second protective layers are identical or compatible.

Compatible means that at least one hardener comprises a mixture of polyisocyanate compounds, and that at least 60% of the composition of the polyisocyanate compounds of one hardener is identical to that of the polyisocyanate compounds of a second hardener, in particular at least 80%.

When the two polyurea-based layers of the protective coating are in contact, they exhibit very good adhesion to each other without the need to introduce a layer of adhesive between them or, in general, without the need to promote adhesion between these layers.

Polyurea-based coatings according to the invention can, in particular, be obtained from at least one hardener selected from polymers of alpha-hydro-omega-hydroxypoly[oxy(methyl-1,2-ethanediyl)] with 1,1′-methylenebis[isocyanatobenzene], the reaction mass of 4,4′-methylene diphenyl diisocyanate (MDI) and o-(pisocyanatobenzyl) phenyl isocyanate, 4,4′-methylene diphenyl diisocyanate (MDI), oligomers of 4,4′-methylene diphenyl diisocyanate (MDI), and mixtures thereof.

Advantageously, at least one polyurea-based layer is obtained from a resin selected from the group consisting of polyoxypropylenediamine; diethylmethylbenzenediamine, glyceryl poly(oxypropylene)triamine; preferably, this is a layer that does not contain an intumescent agent and has the features mentioned above.

Advantageously, at least one polyurea-based layer is obtained from a resin selected from the group consisting of diethylmethylbenzenediamine and oleylamine derivatives, preferably a layer containing an intumescent agent. It preferably also contains at least one compound selected from diammonium decaborate, hexane 6-olide, and unsaturated C18 fatty acids.

Without being bound by any particular theory, the polyurea-based layer containing the intumescent agent confers the fire-resistant properties of the protective coating. The polyurea-based layer containing no intumescent agent provides the impact resistance of the protective coating according to the invention. Both types of layer contribute to the corrosion and chemical resistance of the protective coating according to the invention.

Advantageously, when a liner is present, the liner comprises a cylindrical central portion. For example, the cross-section of the cylindrical central portion is a circle or an ellipse. The composite reinforcing structure surrounds at least part of the liner, for example the cylindrical central portion. The tank thus comprises at least one cylindrical central portion and two dome-shaped ends, and the protective coating comprising the polyurea layers covers at least part of the cylindrical central portion of the tank; the protective coating especially covers at least 80% of the cylindrical central portion of the tank, in particular, at least 90%, for example at least 95%. The protective coating according to the invention can cover the entire cylindrical central portion of the tank.

According to some embodiments of the invention, the protective coating does not cover the dome-shaped ends of the tank.

In other embodiments of the invention, at least one polyurea-based layer of the protective coating covers the ends of the tank.

The ends of the tank can be covered at least in part or entirely by a polyurea-based layer of the coating containing an intumescent agent as defined above.

According to one variant, the ends of the tank are covered at least in part or entirely by a polyurea-based layer of the coating not containing an intumescent agent as defined above. The at least one polyurea-based layer containing an intumescent agent does not cover the ends of the tank.

In another variant, the ends of the tank are covered at least in part by at least one polyurea-based layer not containing an intumescent agent and by at least one polyurea-based layer containing an intumescent agent. In particular, the protective coating as a whole at least partially covers the ends of the tank; it especially covers substantially all the ends of the tank.

The protective coating can be applied or deposited on the tank in accordance with methods known to the person skilled in the art.

It can especially be applied by pressure spraying, dipping, or brushing. Preferably, the coating is applied by spraying.

Advantageously, steps c1 and c2 are performed successively. The time between steps c1) and c2) of applying the two coats is generally less than one hour. The polyurea-based protective layer obtained from the mixture (I) is located on the outside of the protective coating, and is the outermost layer of the protective coating.

According to a variant of the method, at least one additional polyurea-based layer is deposited on the hollow body. The method then comprises at least one further step of depositing a mixture of at least one resin and at least one hardener as defined herein. This step can be performed between steps c1 and c2, or before step c1.

After the steps of depositing the mixtures of successive polyurea-based layers, the resulting product (comprising the hollow body covered with at least two polyurea-based layers) is placed in conditions allowing complete cross-linking and curing of the polyureas.

The polyurea-based coating deposition steps are carried out at a temperature of 15 °C to 75 °C; they can be carried out at room temperature, but this temperature must be greater than or equal to the dew point +3 °C.

In one embodiment of the invention, the polyurea-based layer deposition steps are carried out at room temperature; the hollow body obtained after leaving the furnace is left to stand for a variable length of time, until it cools. The time required to obtain a protective coating comprising polyurea-based layers is less than or equal to twenty-four hours, especially less than or equal to seven hours, generally between three hours and seven hours.

In one embodiment of the invention, the polyurea-based layer deposition steps are carried out directly after the hollow body has been removed from the furnace. Directly means after a period of time less than or equal to one hour after obtaining the hollow body, the temperature of which has not returned to that of room temperature. The surface temperature of the hollow body is approx. 70 °C+/−5 °C. The time required to obtain a protective coating comprising polyurea-based layers is less than or equal to three hours.

The hollow body has a cylindrical central part and two dome-shaped ends. The cylindrical central part is generally covered at least in part by the composite reinforcing structure; the composite reinforcing structure does not cover the dome-shaped ends.

In one embodiment, the mixtures (D) and (I) are deposited on at least 90% of the surface of the cylindrical part of the hollow body, in particular, on the entire surface of the cylindrical part of the hollow body (covered with the composite reinforcing structure). The mixtures can be deposited exclusively on the cylindrical part and/or on at least part of the dome-shaped ends of the hollow body.

According to a variant of the method, at least one of the mixtures (D) and (I) is further deposited on at least part of the dome-shaped ends of the hollow body. It can be the mixture (D) only, the mixture (I) only; advantageously, the mixture (D). In one variant, the mixtures (D) and (I) are deposited on the cylindrical part of the hollow body and on its dome-shaped ends.

The method may especially comprise the following steps, after preparation, using methods known to the person skilled in the art, of the hollow body comprising the composite reinforcing structure and, where appropriate, a liner.

A resin mixture as defined herein is prepared, preferably comprising amines with long, branched polymer chains and few aromatic amines. A hardener as defined herein is also prepared, comprising a mixture of polyisocyanate compounds.

The mixture of resin and hardener is introduced into a mixing chamber of a spraying device, in a stoichiometric ratio of 1:1+/−5%. The reaction is almost immediate, and the polyurea is sprayed onto at least part of the hollow body to form the layer obtained from the mixture (D) (or the layer (D)). The spraying conditions and quantity of mixture are adjusted to obtain a layer (D) with a thickness greater than or equal to 1 mm, and less than or equal to 3 mm, especially less than or equal to 2 mm.

Advantageously, the temperature in the mixing chamber is 80°C+/−10 °C, and the pressure is 180 bar+/−20 bar.

A resin mixture as defined herein is prepared, preferably comprising amines with short aliphatic or aromatic chains and containing an intumescent agent. A hardener as defined herein is also prepared, comprising a mixture of polyisocyanate compounds identical to or compatible with the hardener of the first polyurea layer.

The mixture of resin and hardener is introduced into a mixing chamber of a spraying device, in a stoichiometric ratio of 1:1+/−3%. The reaction is almost immediate; the polyurea is sprayed onto at least part of the hollow body coated with the first mixture of resin and hardener to form the layer obtained from the mixture (I) (or the layer (I)). The spraying conditions and quantity of mixture are adjusted to obtain a layer (I) with a thickness greater than or equal to 1 mm, and less than or equal to 3 mm, especially less than or equal to 2 mm.

Advantageously, the temperature in the mixing chamber is 80 °C+/−10 °C, and the pressure is 180 bar+/−20 bar.

The mixtures of resin and hardener are sprayed onto the hollow body by a spray gun known to the person skilled in the art. For example, an airless gun with a mechanical chamber and a flat spray pattern is used.

The polyurea layers are then left to cure for between three and seven hours at room temperature or in an enclosure maintained at a temperature of around 70 °C.

When the mixture of resins and hardener (optionally comprising at least one agent selected from additives, fillers, and/or fire retardant agents such as intumescent agents) is deposited, polymerization begins. However, the layer is not fully cured when the next polyurea-based layer is applied.

Polymerization is a reaction involving cross-linking. Polymerization is a chemical reaction between molecules, triggered, for example, by a catalyst or reagent, with the action of heat or ambient humidity, by which a molecule with a higher molar mass is formed. The initial molecules may be monomers or prepolymers. Cross-linking refers to the formation of chemical bonds in different spatial directions during polymerization between the polymer chains and the cross-linking agents present in the product. The result is a three-dimensional molecular network that gives the product elasticity and prevents it from creeping.

The product obtainable by a method as described above is one of the objects of the invention.

According to advantageous embodiment of the invention, the mixture of POLYRESYST® H 20020-70 RE resin and POLYRESYST® H 20020-70 HA hardener marketed by Huntsman is used. Said mixture is preferably made in 2/1; 1/2 volume.

According to another advantageous embodiment, the mixture of POLYRESYST H24505-90W HA hardener and POLYRESYST H24505-90W RE resin marketed by Huntsman is used. Said mixture is preferably made in 2/1; 1/2 volume.

In particular, in the method, the mixture of resin and hardener used to prepare the mixture (D) is obtained by mixing the products POLYRESYST® H 20020-70 RE and POLYRESYST® H 20020-70 HA in a ratio of 1:1+/−5% by volume. The reaction is almost immediate, and the polyurea is sprayed onto at least part of the hollow body to form the layer obtained from the mixture (D) (or the layer (D)). The resin mixture used to prepare the mixture (I) is obtained by mixing POLYRESYST H24505-90W HA and POLYRESYST H24505-90W RE. The mixture of resin and hardener is introduced into a mixing chamber of a spraying device, in a ratio of 1:1+/−3%. The reaction is almost immediate; the polyurea is sprayed onto at least part of the hollow body coated with the first mixture of resin and hardener to form the layer obtained from the mixture (I) (or the layer (I)).

The tank having the protective coating comprising two polyurea-based layers is subjected to the tests defined in UN/ECE Regulation No. 134. It meets the standards set out in this regulation.

1. A pressurized tank comprising:
a composite reinforcing structure,
at least partially coated with a protective coating, wherein the protective coating comprises at least two polyurea-based protective layers,
at least one of the protective layers based on one or more polyureas further comprising at least one fire retardant agent which is an intumescent agent,
the one or more polyureas being one or more products of the reaction between at least one hardener and at least one resin, for which
(i) the resin is an aromatic or aliphatic polyamine compound, optionally substituted with at least one alcohol function,
(ii) the hardener is an aromatic, cycloaliphatic, heterocyclic, alicyclic, or aliphatic polyisocyanate compound, and reaction products thereof in the form of aliphatic or aromatic oligomers,
at least one resin of a first polyurea-based protective layer being different from at least one resin of a second polyurea-based protective layer,
the protective layer containing the intumescent agent being the outermost layer of the coating.

2. The pressurized tank according to claim 1, further comprising:
a liner, and
a composite reinforcing structure,
at least partially coated with a protective coating, wherein the protective coating comprises at least two polyurea-based protective layers,
at least one of the protective layers based on one or more polyureas further comprising at least one fire retardant agent which is an intumescent agent,
the one or more polyureas being one or more products of the reaction between at least one hardener and at least one resin, for which
(i) the resin is an aromatic or aliphatic polyamine compound, optionally substituted with at least one alcohol function,
(ii) the hardener is an aromatic, cycloaliphatic, heterocyclic, alicyclic, or aliphatic polyisocyanate compound, and reaction products thereof in the form of aliphatic or aromatic oligomers,
at least one resin of a first polyurea-based protective layer being different from at least one resin of a second polyurea-based protective layer,
the protective layer containing the intumescent agent being the outermost layer of the coating.

3. The tank according to claim 1, wherein the overall thickness of the protective coating is less than or equal to 12 mm.

4. The tank according to claim 1, wherein the intumescent agent is selected from the group of halogen compounds, phosphorus compounds, boron compounds, metal hydroxides, and metal oxides, and the mixture of at least two of these.

5. The tank according to claim 1, wherein at least one of the polyurea-based protective layers contains at least one filler, in particulate or fibrous form, said filler being selected from ceramics, metals, metal oxides, plastics, and mixtures thereof.

6. The tank according to claim 1, wherein at least one of the polyurea-based protective layers does not contain a fire retardant agent which is an intumescent agent.

7. The tank according to claim 1, wherein at least one of the polyurea-based protective layers contains at least one additive selected from UV absorbers, light stabilizers, antioxidants, dispersing agents, wetting agents plasticizing agents, anti-foaming agents, and impact attenuators.

8. The tank according to claim 1, further comprising at least one cylindrical central portion and two dome-shaped ends, wherein the protective coating covers the cylindrical central portion of the tank.

9. The tank according to claim 1, further comprising at least one cylindrical central portion and two dome-shaped ends, wherein at least one polyurea-based layer of the protective coating covers the ends of the tank.

10. The tank according to claim 1, wherein the hardeners for each of the polyurea-based layers are compatible or identical.

11. The tank according to claim 1, wherein at least one hardener is selected from polymers of alpha-hydro-omega-hydroxypoly[oxy(methyl-1,2-ethanediyl)] with 1,1′-methylenebis[isocyanatobenzene], the reaction mass of 4,4′-methylene diphenyl diisocyanate (MDI) and o-(p-isocyanatobenzyl)phenyl isocyanate, 4,4′-methylene diphenyl diisocyanate (MDI), and oligomers of 4,4′-methylene diphenyl diisocyanate (MDI).

12. The tank according to claim 1, wherein at least one polyurea-based layer is obtained from a resin selected from the group consisting of polyoxypropylenediamine, diethylmethylbenzenediamine, glyceryl poly(oxypropylene)triamine, polyalkylamine, and polyarylamine,
and wherein at least one polyurea-based layer is obtained from a resin selected from the group consisting of diethylmethylbenzenediamine and oleylamine derivatives.

13. A vehicle comprising a tank according to claim 1.

14. A method for preparing a tank according to claim 1, comprising
a) obtaining a mandrel,
b) winding a composite reinforcing structure around at least part of the mandrel to obtain a hollow body,
c) forming a protective coating on at least part of the surface of the composite reinforcing structure, the forming comprising:
c1) depositing a mixture (D) of at least one resin and at least one hardener, on at least part of the composite reinforcing structure, the stoichiometric ratio of resin to hardener being between 2:1 and 1:2, and polymerizing the mixture (D) to obtain a first polyurea-based protective layer,
c2) depositing a mixture (I) of at least one resin, at least one hardener, and at least one fire retardant agent, on at least part of the surface of the hollow body coated with a protective layer obtained in step c1), the stoichiometric ratio of resin to hardener being between 2:1 and 1:2, and polymerizing the mixture (1) to obtain a second polyurea-based protective layer,
at least one resin in the mixture (D) being different from at least one resin in the mixture (I).

15. The method for preparing a tank according to claim 14, further comprising:
a) obtaining a mandrel which is a liner,
b) winding a composite reinforcing structure around at least part of said liner to obtain a hollow body,
c) forming a protective coating on at least part of the surface of the composite reinforcing structure, the forming comprising:
c1) depositing a mixture (D) of at least one resin and at least one hardener, on at least part of the composite reinforcing structure, the stoichiometric ratio of resin to hardener being between 2:1 and 1:2, and polymerizing the mixture (D) to obtain a first polyurea-based protective layer,
c2) depositing a mixture (I) of at least one resin, at least one hardener, and at least one fire retardant agent, on at least part of the surface of the hollow body coated with a protective layer obtained in step c1), the stoichiometric ratio of resin to hardener being between 2:1 and 1:2, and polymerizing the mixture (I) to obtain a second polyurea-based protective layer,
at least one resin in the mixture (D) being different from at least one resin in the mixture (I).

16. The method for preparing a tank according to claim 14, wherein steps c1 and c2 are carried out successively, and wherein the polyurea-based protective layer obtained from the mixture (I) is located on the outside of the coating.

17. The method for preparing a tank according to claim 14, wherein at least one additional step of depositing a mixture of at least one resin and at least one hardener is carried out between steps c1) and c2).
